(19) United States
(12) Patent Application Publication
(10) Pub. No.: US 2026/0278809 A1
(43) Pub. Date: Sep. 17, 2026

(54) SYSTEM AND METHOD FOR CLASS-AGNOSTIC COUNTING OF ONE OR MORE ITEMS IN A CONTAINER

(71) Applicant: NTT Ltd Group Services America, Inc., Greenwood Village, CO (US)

(72) Inventors: Sai Kwong Yusuf MAI, Richmond (CA); Mingrui YU, Markham (CA)

(21) Appl. No.: 19/078,802

(22) Filed: Mar. 13, 2025

(51) Int. Cl. G06T 7/215; G06T 7/564; G06T 7/73

(52) U.S. Cl. CPC G06T 7/215; G06T 7/564; G06T 7/73; G06T 2207/30242

(57) ABSTRACT

The present application pertains to systems and methods of tracking, control, management and counting of objects, items or materials within a monitored area. More particularly, embodiments relate to systems and processes for class-agnostic counting of one or more items in a container in the monitored area.

### FIELD OF THE INVENTION

Embodiments described herein are employed for tracking, control, management and counting of objects, items or materials within a monitored area. More particularly, embodiments relate to systems and processes for class-agnostic counting of one or more items in a container in the monitored area.

### BACKGROUND

In everyday life, counting objects is very common and happens very frequently. However, with the current state of technology, counting objects has been either cumbersome or inaccurate. RFID were used in the past 15 years as a serialisation mechanism for objects, and with each object serialised, a system can count the quantity. However, tagging RFID labels to objects is a cumbersome and labor-intensive, and reading RFID tags over RF is susceptible to environmental factors. Engineers and scientist started using computer vision to count objects; however, this can only be feasible for cases where there is a fixed range of variety of objects (e.g. counting people, counting cars where a neural network can be trained on car images or images with people). For cases where there is endless variations of objects that needs to be counted, the current state of computer vision is not practical. Counting is nonetheless a key part of many processes across any sectors (industrial, commercial, consumer, etc.). Therefore, there is a need for better systems and processes to track and to count objects, any type of objects.

### SUMMARY

In one aspect, a method of class-agnostic counting of one or more items in a container is disclosed. One embodiment of the method comprises (a) receiving, from one or more detection devices, image data of one or more items of interest placed in a container and a background, the image data comprising three-dimensional (3-D) image data and a two-dimensional (2-D) image data of one or more items of interest placed in the container and the background; (b) obtaining depth information for each pixel of the 3D image data; (c) generating, using the depth information, one or more depth masks corresponding to each of one or more items of interest; (d) extracting, using the one or more depth masks and the 2-D image data, the one or more items of interest from the background to individually segment each of the one or more items of interest; (e) performing a count of the individually segmented one or more items of interest; (f) performing object tracking by tracking a location of the container and/or the one or more items of interest in an area; (g) detecting, using motion detection, if one or more of the items of interest in the container have been removed and/or if additional items of interest have been added to the container; and (h) repeating steps a.-g. until the one or more items of interest and the container reach an exit point in the area, wherein a last count of the one or more items of interest in the container is set as a final count of the one or more items of interest in the container.

In some instances of the method, individually segmenting each of the one or more items of interest comprises detecting contours of each of the one or more items of interest using computer vision techniques, where detecting the contours of each of the one or more items of interest comprises identifying boundaries of all of the one or more items of interest based on the one or more depth masks. In some instances, if the identified boundary of an item of interest has an irregular shape, then using the object tracking to determine if the irregularly-shaped item of interest is a single object or a plurality of objects grouped together.

In some instances of the method, detecting, using motion detection, if one or more of the items of interest in the container have been removed and/or if additional items of interest have been added to the container comprises detecting an arm moving over and/or toward the container, or detecting the arm moving away from the container. For example, the arm may be a human arm or a mechanical arm, such as the arm of a robotic device.

In some instances of the method, detecting the arm moving over and/or toward the container, or detecting the arm moving away from the container further comprises detecting a human hand moving over and/or toward the container, or detecting the human hand moving away from the container. In other instances, detecting the arm moving over and/or toward the container, or detecting the arm moving away from the container further comprises detecting a mechanical hand or gripper moving over and/or toward the container, or detecting the mechanical hand or gripper moving away from the container.

In some instances of the method, at least one of the one or more detection devices comprises a stereoscopic camera, an RGB camera, or LIDAR.

In another aspect, a system of class-agnostic counting of one or more items in a container is disclosed. One embodiment of the system comprises one or more detection devices. The one or more detection devices are in communication with one or more processors, and the one or more processors are in communication with a memory. The memory has stored thereon computer-executable code sections that cause the processor to: (a) receive, from the one or more detection devices, image data of one or more items of interest placed in a container and a background, the image data comprising a three-dimensional (3-D) image data and a two-dimensional (2-D) image data of one or more items of interest placed in the container, and the background; (b) obtain depth information for each pixel of the 3D image data; (c) generate, using the depth information, one or more depth masks corresponding to each of one or more items of interest; (d) extract, using the one or more depth masks and the 2-D image data, the one or more items of interest from the background to individually segment each of the one or more items of interest; (e) perform a count of the individually segmented one or more items of interest; (f) perform object tracking by tracking a location of the container and/or the one or more items of interest in an area; (g) detect, using motion detection, if one or more of the items of interest in the container have been removed and/or if additional items of interest have been added to the container; and (h) repeat steps a.-g. until the one or more items of interest and the container reach an exit point in the area, wherein a last count of the one or more items of interest in the container is set as a final count of the one or more items of interest in the container.

In some instances of the system, individually segmenting each of the one or more items of interest comprises detecting contours of each of the one or more items of interest using computer vision techniques, where detecting the contours of each of the one or more items of interest comprises identifying boundaries of all of the one or more items of interest based on the one or more depth masks. In some instances, if the identified boundary of an item of interest has an irregular shape, then the object tracking is used to determine if the irregularly-shaped item of interest is a single object or a plurality of objects grouped together.

In some instances of the system, detecting, using motion detection, if one or more of the items of interest in the container have been removed and/or if additional items of interest have been added to the container comprises detecting an arm moving over and/or toward the container, or detecting the arm moving away from the container. For example, the arm may be a human arm or a mechanical arm, such as the arm of a robotic device.

In some instances of the system, detecting the arm moving over and/or toward the container, or detecting the arm moving away from the container further comprises detecting a human hand moving over and/or toward the container, or detecting the human hand moving away from the container. In other instances, detecting the arm moving over and/or toward the container, or detecting the arm moving away from the container further comprises detecting a mechanical hand or gripper moving over and/or toward the container, or detecting the mechanical hand or gripper moving away from the container.

In some instances of the system, at least one of the one or more detection devices comprises a stereoscopic camera, an RGB camera, or LIDAR.

In yet another aspect, a non-transitory computer-readable medium having computer-executable code sections stored thereon for execution a method of class-agnostic counting of one or more items in a container is disclosed. One embodiment of the method comprises (a) receiving, from one or more detection devices, image data of one or more items of interest placed in a container and a background, the image data comprising three-dimensional (3-D) image data and a two-dimensional (2-D) image data of one or more items of interest placed in the container and the background; (b) obtaining depth information for each pixel of the 3D image data; (c) generating, using the depth information, one or more depth masks corresponding to each of one or more items of interest; (d) extracting, using the one or more depth masks and the 2-D image data, the one or more items of interest from the background to individually segment each of the one or more items of interest; (e) performing a count of the individually segmented one or more items of interest; (f) performing object tracking by tracking a location of the container and/or the one or more items of interest in an area; (g) detecting, using motion detection, if one or more of the items of interest in the container have been removed and/or if additional items of interest have been added to the container; and (h) repeating steps a.-g. until the one or more items of interest and the container reach an exit point in the area, wherein a last count of the one or more items of interest in the container is set as a final count of the one or more items of interest in the container.

In some instances of the method, individually segmenting each of the one or more items of interest comprises detecting contours of each of the one or more items of interest using computer vision techniques, where detecting the contours of each of the one or more items of interest comprises identifying boundaries of all of the one or more items of interest based on the one or more depth masks. In some instances, if the identified boundary of an item of interest has an irregular shape, then using the object tracking to determine if the irregularly-shaped item of interest is a single object or a plurality of objects grouped together.

In some instances of the method, detecting, using motion detection, if one or more of the items of interest in the container have been removed and/or if additional items of interest have been added to the container comprises detecting an arm moving over and/or toward the container, or detecting the arm moving away from the container. For example, the arm may be a human arm or a mechanical arm, such as the arm of a robotic device.

In some instances of the method, detecting the arm moving over and/or toward the container, or detecting the arm moving away from the container further comprises detecting a human hand moving over and/or toward the container, or detecting the human hand moving away from the container. In other instances, detecting the arm moving over and/or toward the container, or detecting the arm moving away from the container further comprises detecting a mechanical hand or gripper moving over and/or toward the container, or detecting the mechanical hand or gripper moving away from the container.

In some instances of the method, at least one of the one or more detection devices comprises a stereoscopic camera, an RGB camera, or LIDAR.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is an overview illustration of an exemplary system for of class-agnostic counting of one or more items in a container.

FIG. 2 illustrates a non-limiting example of a system for class-agnostic counting of one or more items in a container in an area.

FIG. 3 is a flowchart illustrating an exemplary method of class-agnostic counting of one or more items in a container.

FIG. 4 illustrates an example computing environment in which example embodiments and aspects may be implemented.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

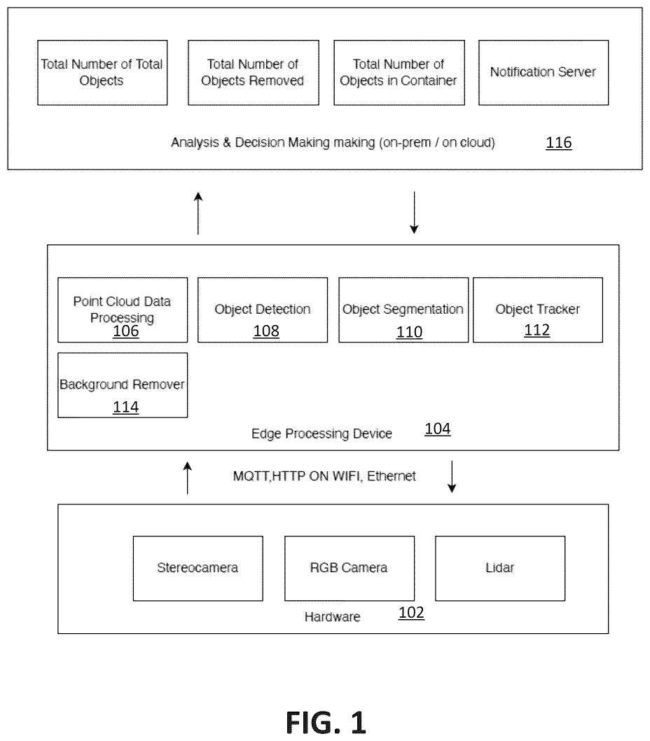

FIG. 1 is an overview illustration of an exemplary system for of class-agnostic counting of one or more items in a container. Generally, as shown in the embodiment of FIG. 1, the system utilizes one or more detection devices 102 such as stereoscopic cameras, RGB cameras, and the like. In some instance, the detection device 102 comprises one or more cameras with suitable specifications such as resolution, frame rate, and focal length. The one or more detection devices are positioned to capture the scene containing the items of interest in an area.

The one or more detection devices are in communication with one or more processors. Generally, such communications occur over a network, which can be wired (including fiber optic), wireless or combinations thereof using various protocols. In some instances, the one or more processors comprise all or a portion of an edge device 104, as shown in FIG. 1. The exemplary edge device 104 of FIG. 1 is comprised of a point-cloud data processor 106, an objection detector 108, an object segmenter 110, an object tracker 112, and a background remover 114. In some instances, the edge device 104 may be in further communication with an analysis and decision making system 116, which may be located on-premise with the edge device or cloud based. Communications between the edged device 104 and the analysis and decision making system 116 through a network, which can also be wired (including fiber optic), wireless or combinations thereof using various protocols.

Data from the detection device 102 is received by the edge device 104. Such data may include image data of one or more items of interest placed in a container and a background. The image data comprises three-dimensional (3-D) image data and a two-dimensional (2-D) image data of one or more items of interest placed in the container and the background. The items of interest are extracted from the background by the background remover 114 to isolate them for further processing. This is achieved using techniques such as transparent background. By identifying and removing the background, only the items of interest remain visible in the captured image. This may be, in some instances, performed by the background remover 114 obtaining depth information for each pixel of the 3D image data; generating, using the depth information, one or more depth masks corresponding to each of one or more items of interest; and extracting, using the one or more depth masks and the 2-D image data, the one or more items of interest from the background to individually segment each of the one or more items of interest. In some instances, depth information is generated by the object detector 108 using depth sensing technology such as time-of-flight (ToF) sensors or stereo vision systems. This provides accurate depth data for each pixel in the image. The depth information from the object detector 108 feeds into an object segmenter 110 executing a segmentation algorithm. The segmentation algorithm analyzes the scene to identify and segment individual items from the background. It generates the depth masks or regions of interest corresponding to each item in the image. Using computer vision techniques, contours of the segmented items are detected. This involves identifying the boundaries of all items based on the depth masks. Both, 2D and 3D data is used and processed by the point-cloud data processor 106, the object detector 108, and object segmenter.

At this point, the edge device 104 performs a first count of the individually segmented one or more items of interest using the point-cloud data processor 106. This count may be passed on through a network to other systems such as the analysis and decision making system 116, which may be located locally or cloud-based.

The object tracker 112 is employed to monitor objects and for tracking a location of the container and/or the one or more items of interest in an area as objects are removed or added, the overall count of objects will fluctuate. For example, the object tracker 112 may use motion detection to detect if one or more of the items of interest in the container have been removed and/or if additional items of interest have been added to the container. This may be performed by detecting an arm moving over and/or toward the container, or detecting the arm moving away from the container. In some instances, the arm may be a human arm. In such instances, detecting the arm moving over and/or toward the container, or detecting the arm moving away from the container may further comprise detecting a human hand moving over and/or toward the container, or detecting the human hand moving away from the container.

In other instances, the arm may be a mechanical arm (e.g., a robotic arm). In such instances, detecting the arm moving over and/or toward the container, or detecting the arm moving away from the container may further comprise detecting a mechanical hand or gripper moving over and/or toward the container, or detecting the mechanical hand or gripper moving away from the container.

Further, if the identified boundary of an item of interest has an irregular shape, then the object tracker 112 is used to determine if the irregularly-shaped item of interest is a single object or a plurality of objects grouped together. Depth information is utilized for identification and the object tracker 112 to verify whether the irregularly shaped item remains the same. For example, if all parts of the detected shape move together consistently across image frames, it is likely a single object. If different parts exhibit independent motion, it may be a group of objects; the object tracker assesses whether the points belong to a continuous surface or if there are distinct depth separations, which suggests the irregularly-shaped item of interest comprises multiple objects.

The system repeats the above-described processes as the one or more items of interest and/or the container moves around the area. A final count is performed when the items of interest and/or the container reach an exit point in the area, where a last count of the one or more items of interest and/or items in the container is set as a final count of the one or more items of interest in the container. This final count involves counting the total number of items based on the detected contours, segmentation information, and object tracking. By analyzing the spatial relationships between the contours and segmentation data, the system can accurately determine the presence of each item.

As noted above, the final count may be passed on to other systems, such as the analysis and decision making system 116.

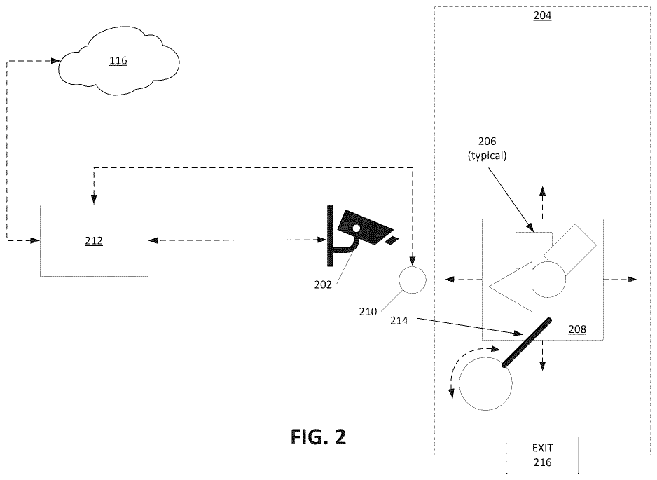

FIG. 2 illustrates a non-limiting example of the system described above for class-agnostic counting of one or more items 206 in a container 208 in an area 204. As shown in FIG. 2, one or more detection devices 202 such as RGB cameras, stereoscopic cameras, and/or time-of-flight (ToF) sensors (e.g., LIDAR-light detection and ranging), combinations of these, and the like, may be positioned to view the area 204. As used herein, “camera” refers to any image capture device capable of capturing one or more still images and/or videos. Further comprising the system shown in FIG. 2 is a detector 210, such as a motion detector. The detector can detect movement within the area 204. Both the detector 210 and the detection device 202 are in communication with a computing device 212 comprising at least a processor and a memory. In some instances, the computing device 212 may be referred to as an “edge device.” Typically, the detection device 202 and the detector 210 employed are configured to transmit and receive both signals and data with the computing device 212. In this manner the camera receives signals commanding it to operate from, for example, the detector 210 and may communicate photos, videos and/or data obtained to a processor of computing device 212.

Generally, the detection device 202 remains in a wait mode until some event causes it to take a photo or begin recording. In some instances, detector 212 such as a motion detector is operably connected to the computing device 212 and configured to cause the computing device 212 to communicate a signal to the detection device 202 to take a photo or start recording upon detection of movement within the area 204. In some embodiments the camera and the motion detector may be integrated into the same device or instrument. The specific type of motion detector may be selected depending upon the specifics of the system, the selected environment, and desired results. Thus, various motion detectors may be employed such as passive infrared sensors, microwave sensors, dual tech or hybrid sensors, or combinations thereof.

Referring to FIG. 1, the exemplary computing device 212 of FIG. 2 is comprised of a point-cloud data processor 106, an objection detector 108, an object segmenter 110, and object tracker 112, and a background remover 114. In some instances, the computing device 212 may be in further communication with an analysis and decision making system 116, which may be located on-premise with the computing device 212 or cloud based.

The detection device 202 and/or the detector 210 monitor the movement of the container 208 within the area 204, as well as items 206 placed within the contained 208 or removed from it. Data from the detection device 202 and/or the detector 210 is received by the computing device 212. Such data may include image data of one or more items of interest 206 placed in the container 208 and a background of the items of interest. The image data comprises three-dimensional (3-D) image data and a two-dimensional (2-D) image data of the one or more items of interest 206 placed in the container 208 and the background. The items of interest 206 are extracted from the background by the background remover 114 to isolate them for further processing. This is achieved using techniques such as transparent background. By identifying and removing the background, only the items of interest 206 remain visible in the captured image. This may be, in some instances, performed by the background remover 114 obtaining depth information for each pixel of the 3D image data; generating, using the depth information, one or more depth masks corresponding to each of one or more items of interest; and extracting, using the one or more depth masks and the 2-D image data, the one or more items of interest from the background to individually segment each of the one or more items of interest. In some instances, depth information is generated by the object detector 108 using depth sensing technology such as time-of-flight (ToF) sensors or stereo vision systems. This provides accurate depth data for each pixel in the image. The depth information from the object detector 108 feeds into an object segmenter 110 executing a segmentation algorithm. The segmentation algorithm analyzes the scene to identify and segment individual items from the background. It generates the depth masks or regions of interest corresponding to each item in the image. Using computer vision techniques, contours of the segmented items are detected. This involves identifying the boundaries of all items based on the depth masks.

The computing device 212 performs a first count of the individually segmented one or more items of interest using the point-cloud data processor 106. This count may be passed on through a network to other systems such as the analysis and decision making system 116, which may be located locally or cloud-based. The object tracker 112 is employed to monitor objects and for tracking a location of the container 208 and/or the one or more items of interest 206 in the area 204 as objects are removed or added, the overall count of objects will fluctuate. For example, the object tracker 112 may use motion detection to detect if one or more of the items of interest 206 in the container 208 have been removed and/or if additional items of interest 206 have been added to the container 208. This may be performed by detecting an arm 214 moving over and/or toward the container 208, or detecting the arm 214 moving away from the container 208. Though shown in FIG. 2 as a robotic arm, in some instances, the arm may be a human arm. In such instances, detecting the arm 214 moving over and/or toward the container 208, or detecting the arm 214 moving away from the container 208 may further comprise detecting a human hand moving over and/or toward the container, or detecting the human hand moving away from the container. In such instances where the arm 214 moving over and/or toward the container 208 or away from the container 208 comprises a mechanical arm 214, motion detection and/or computer vision techniques may be used to detect a mechanical hand or gripper moving over and/or toward the container 208, or detecting the mechanical hand or gripper moving away from the container 208.

Further, if the identified boundary of one or more items of interest 206 have an irregular shape, such as the outline of the group of items 206 shown in FIG. 2, then the object tracker 112 is used to determine if the irregularly-shaped item of interest is a single object or a plurality of objects grouped together. As shown in FIG. 2, the object tracker 112 would determine that the irregular shape is caused by a plurality of objects 206 grouped together.

The system repeats the above-described processes as the one or more items of interest 206 and/or the container 208 moves around the area 204. A final count is performed when the items of interest 206 and/or the container 208 reach an exit point 216 in the area 204, where a last count of the one or more items of interest 206 and/or items in the container 208 is set as a final count of the one or more items of interest 206 in the container 208. This final count involves counting the total number of items based on the detected contours, segmentation information, and object tracking. By analyzing the spatial relationships between the contours and segmentation data, the system can accurately determine the presence of each item. As noted above, the final count may be passed by the computing device 212 on to other systems, such as the analysis and decision making system 116.

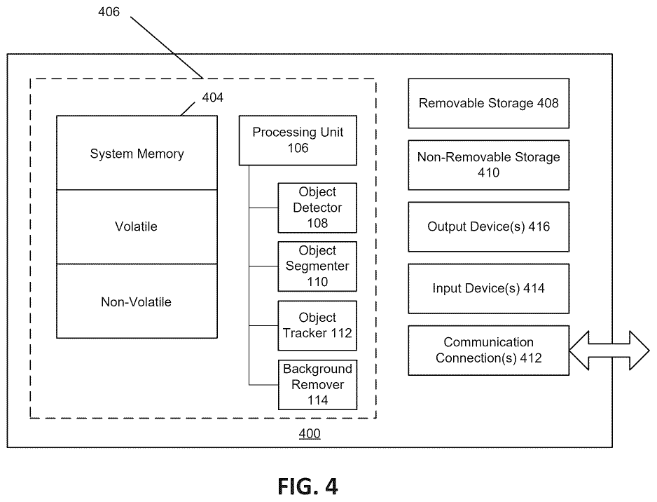

Asa noted above, the processor 106 is operably linked to the detection device 202. As used herein, “linked” may mean a wired connection (including fiber optics), a wireless connection, or combinations thereof. The processor 106 is configured to receive data from the detection device(s) 202, track the movement of the container 208 within the area, track and identify items of interest 206 as they are placed into or removed from the container 208, reiteratively count the items of interest 206 within the container 208, determine a final identification and count of the items of interest 206 in the container 208 at an exit 216 from the area 204, and pass information about the count, identification, and the like to other systems, such as the analysis and decision making system 116. The processor 106 executes computer-executable instructions stored in a memory that cause the processor 106 to perform these actions. An exemplary computing device 600 that contains a processor 106 and that may be used in embodiments disclosed herein is shown in FIG. 4 and described in greater detail herein.

The processor 106 may be configured to support one or more additional functions, if desired. For example, the processor 106 may be in communication with a memory (see FIG. 4) configured to store images, videos and other data received from the detection devices 202. The memory may be integrated with and into the processor 106, or may be separate from the processor 106. Alternatively or additionally, the processor 106 may comprise part of a cloud network and/or operably connected to a cloud database stored in the cloud network that is configured to receive the images, videos and other data). In either case, if a machine learning or other artificial intelligence program is being used by the processor 106, then the stored images, videos and other data may be used to support that function. For example, in some embodiments the processor 106 may employ one or a plurality of computer vision and/or feature detection algorithms including, but not limited to a histogram of oriented gradients (HOG), integral channel features (ICF), aggregated channel features (ACF), deformable part models (DPM), and the like. In some embodiments the processor 106 may employ object detection. Such object detection may include, for example, an other region proposal classification network (RCNN), a fully convolutional neural network (FCNN), a you only look once network (YOLO), or a combination thereof. In some embodiments, tracking algorithms may also be utilized including, but not limited to Kalman filters, particle filters, and/or Markov chain Monte Carlo (MCMC) tracking approaches.

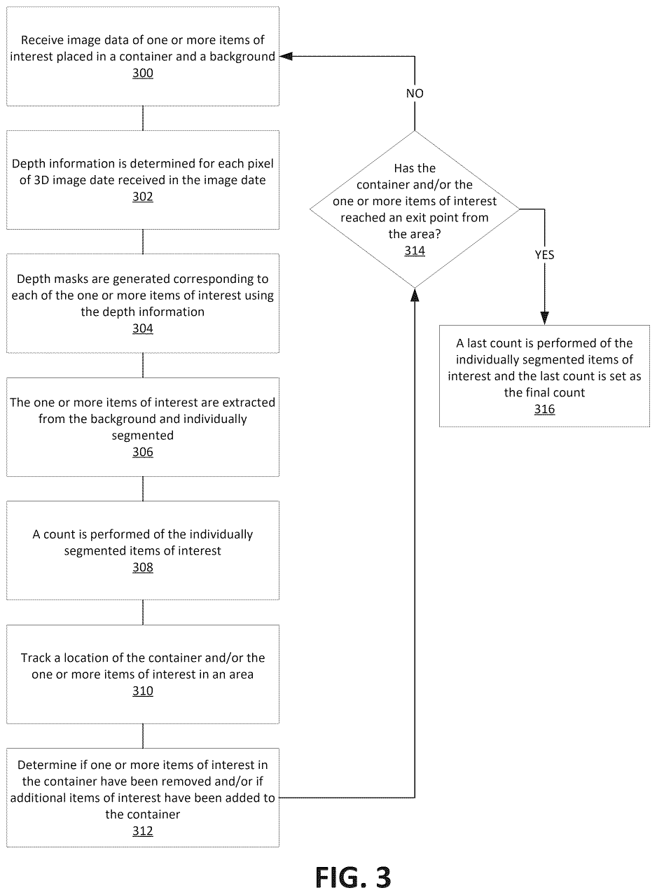

FIG. 3 is a flowchart illustrating an exemplary method of class-agnostic counting of one or more items in a container. At 300, image data of one or more items of interest placed in a container and a background is received. Generally, the image data comprises three-dimensional (3-D) image data and a two-dimensional (2-D) image data of the one or more items of interest placed in the container and the background. Generally, the image date is received from one or more detection devices, and may be accompanied by additional data from the one or more detection devices. Examples of detection devices include stereoscopic cameras, RGB cameras, time-of-flight sensors such as LIDAR, and the like. At 302, depth information is determined for each pixel of the 3D image data. At 304, using the depth information, one or more depth masks corresponding to each of one or more items of interest are generated. At 306, the one or more items of interest are extracted from the background and individually segmented. Generally, this comprises extracting, using the one or more depth masks and the 2-D image data, the one or more items of interest from the background to individually segment each of the one or more items of interest. In some instances, individually segmenting each of the one or more items of interest comprises detecting contours of each of the one or more items of interest using computer vision techniques, wherein detecting the contours of each of the one or more items of interest comprises identifying boundaries of all of the one or more items of interest based on the one or more depth masks. In some instances, if the identified boundary of an item of interest has an irregular shape, then using the object tracking to determine if the irregularly-shaped item of interest is a single object or a plurality of objects grouped together.

At 308, a count of the individually segmented one or more items of interest is performed. At 310, a location of the container and/or the one or more items of interest in an area is tracked. At 312, it is detected, using motion detection, if one or more of the items of interest in the container have been removed and/or if additional items of interest have been added to the container. In some instances, detecting, using motion detection, if one or more of the items of interest in the container have been removed and/or if additional items of interest have been added to the container comprises detecting an arm moving over and/or toward the container, or detecting the arm moving away from the container. The arm may be a human arm or a robotic arm.

At 314, it is determined whether the container and/or the one or more items of interest have reached an exit point from the area. If, at 314, it is determined that the container and/or the one or more items of interest have not reached an exit point, then the process returns to step 300. If, at 314, it is determined that the container and/or the one or more items of interest have reached the exit point from the area, then at 316 a last count of the one or more items of interest in the container is set as a final count of the one or more items of interest in the container.

FIG. 4 illustrates an example computing environment in which example embodiments and aspects may be implemented. The illustrated computing device may comprise all or part of a cloud-based network and/or a processor associated with the edge device described herein. As used herein, “computer,” “processor,” and “computing device” may refer to a singular device and/or may refer to a plurality of “computers,” “processors,” and “computing devices.” The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, cloud-based systems, microprocessor-based systems, network personal computers (PCs), minicomputers, mainframe computers, embedded systems, distributed computing environments that include any of the above systems or devices, and the like. The computing environment may include a cloud-based computing environment.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an example system for implementing aspects described herein includes a computing device, such as computing device 400. In its most basic configuration, computing device 400 typically includes at least one processing unit 106 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by the device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by computing device 400. Any such computer storage media may be part of computing device 400.

Computing device 400 may contain communication connection(s) 412 that allow the device to communicate with other devices and/or systems. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of class-agnostic counting of one or more items in a container, said method comprising:
a. receiving, from one or more detection devices, image data of one or more items of interest placed in a container and a background, said image data comprising three-dimensional (3-D) image data and a two-dimensional (2-D) image data of one or more items of interest placed in the container and the background;
b. obtaining depth information for each pixel of the 3D image data;
c. generating, using the depth information, one or more depth masks corresponding to each of one or more items of interest;
d. extracting, using the one or more depth masks and the 2-D image data, the one or more items of interest from the background to individually segment each of the one or more items of interest;
e. performing a count of the individually segmented one or more items of interest;
f. performing object tracking by tracking a location of the container and/or the one or more items of interest in an area;
g. detecting, using motion detection, if one or more of the items of interest in the container have been removed and/or if additional items of interest have been added to the container; and
h. repeating steps a.-g. until the one or more items of interest and the container reach an exit point in the area, wherein a last count of the one or more items of interest in the container is set as a final count of the one or more items of interest in the container.

2. The method of claim 1, wherein individually segmenting each of the one or more items of interest comprises detecting contours of each of the one or more items of interest using computer vision techniques, wherein detecting the contours of each of the one or more items of interest comprises identifying boundaries of all of the one or more items of interest based on the one or more depth masks.

3. The method of claim 2, wherein if the identified boundary of an item of interest has an irregular shape, then using the object tracking to determine if the irregularly-shaped item of interest is a single object or a plurality of objects grouped together.

4. The method of claim 1, wherein detecting, using motion detection, if one or more of the items of interest in the container have been removed and/or if additional items of interest have been added to the container comprises detecting an arm moving over and/or toward the container, or detecting the arm moving away from the container.

5. The method of claim 4, wherein the arm is a human arm.

6. The method of claim 5, wherein detecting the arm moving over and/or toward the container, or detecting the arm moving away from the container further comprises detecting a human hand moving over and/or toward the container, or detecting the human hand moving away from the container.

7. The method of claim 4, wherein the arm is a mechanical arm.

8. The method of claim 7, wherein detecting the arm moving over and/or toward the container, or detecting the arm moving away from the container further comprises detecting a mechanical hand or gripper moving over and/or toward the container, or detecting the mechanical hand or gripper moving away from the container.

9. The method of claim 1, wherein at least one of the one or more detection devices comprises a stereoscopic camera, an RGB camera, or LIDAR.

10. A system for class-agnostic counting of one or more items in a container comprising:
one or more detection devices;
one or more processors, wherein the one or more processors are in communication with the one or more detection devices, and the one or more processors are in communication with a memory, the memory having stored thereon computer-executable code sections that cause the processor to:
(a) receive, from the one or more detection devices, image data of one or more items of interest placed in a container and a background, the image data comprising a three-dimensional (3-D) image data and a two-dimensional (2-D) image data of one or more items of interest placed in the container, and the background;
(b) obtain depth information for each pixel of the 3D image data;
(c) generate, using the depth information, one or more depth masks corresponding to each of one or more items of interest;
(d) extract, using the one or more depth masks and the 2-D image data, the one or more items of interest from the background to individually segment each of the one or more items of interest;
(e) perform a count of the individually segmented one or more items of interest; (f) perform object tracking by tracking a location of the container and/or the one or more items of interest in an area;
(g) detect, using motion detection, if one or more of the items of interest in the container have been removed and/or if additional items of interest have been added to the container; and
(h) repeat steps a.-g. until the one or more items of interest and the container reach an exit point in the area, wherein a last count of the one or more items of interest in the container is set as a final count of the one or more items of interest in the container.

11. The system of claim 10, wherein individually segmenting each of the one or more items of interest comprises detecting contours of each of the one or more items of interest using computer vision techniques, where detecting the contours of each of the one or more items of interest comprises identifying boundaries of all of the one or more items of interest based on the one or more depth masks.

12. The system of claim 11, wherein if the identified boundary of an item of interest has an irregular shape, then the object tracking is used to determine if the irregularly-shaped item of interest is a single object or a plurality of objects grouped together.

13. The system of claim 10, wherein detecting, using motion detection, if one or more of the items of interest in the container have been removed and/or if additional items of interest have been added to the container comprises detecting an arm moving over and/or toward the container, or detecting the arm moving away from the container.

14. The system of claim 13, wherein the arm comprises a human arm.

15. The system of claim 14, wherein detecting the arm moving over and/or toward the container, or detecting the arm moving away from the container further comprises detecting a human hand moving over and/or toward the container, or detecting the human hand moving away from the container.

16. The system of claim 13, wherein the arm comprises a mechanical arm.

17. The system of claim 16, wherein detecting the arm moving over and/or toward the container, or detecting the arm moving away from the container further comprises detecting a mechanical hand or gripper moving over and/or toward the container, or detecting the mechanical hand or gripper moving away from the container.

18. The system of claim 17, wherein at least one of the one or more detection devices comprises a stereoscopic camera, and RGB camera, or LIDAR.

19. A non-transitory computer-readable medium having computer-executable code sections stored thereon for execution a method of class-agnostic counting of one or more items in a container, said method comprising:
(a) receiving, from one or more detection devices, image data of one or more items of interest placed in a container and a background, the image data comprising three-dimensional (3-D) image data and a two-dimensional (2-D) image data of one or more items of interest placed in the container and the background;
(b) obtaining depth information for each pixel of the 3D image data;
(c) generating, using the depth information, one or more depth masks corresponding to each of one or more items of interest;
(d) extracting, using the one or more depth masks and the 2-D image data, the one or more items of interest from the background to individually segment each of the one or more items of interest;
(e) performing a count of the individually segmented one or more items of interest;
(f) performing object tracking by tracking a location of the container and/or the one or more items of interest in an area;
(g) detecting, using motion detection, if one or more of the items of interest in the container have been removed and/or if additional items of interest have been added to the container; and
(h) repeating steps a.-g. until the one or more items of interest and the container reach an exit point in the area, wherein a last count of the one or more items of interest in the container is set as a final count of the one or more items of interest in the container.

20. The computer program product of claim 19, wherein at least one of the one or more detection devices comprises a stereoscopic camera, an RGB camera, or LIDAR.
